(19) United States
(12) Patent Application Publication
(10) Pub. No.: US 2008/0218354 A1
(43) Pub. Date: Sep. 11, 2008

(54) NON-NETWORKED RFID SYSTEM

(76) Inventors: Robert D. Lorentz, North Oaks, MN (US); Ronald D. Jesme, Plymouth, MN (US); Robert A. Sainati, Bloomington, MN (US); James P. McGee, Cedar, MN (US); Michael E. Hamerly, Vadnais Heights, MN (US); Subhalakshmi M. Ananthanarayanan, Woodbury, MN (US)

Correspondence Address: 3M INNOVATIVE PROPERTIES COMPANY, PO BOX 33427, ST. PAUL, MN, 55133-3427, US

(21) Appl. No.: 11/684,398

(22) Filed: Mar. 9, 2007

(51) Int. Cl. G08B 13/14

(52) U.S. Cl. 340/572.7; 340/572.1

(57) ABSTRACT

Non-networked radio frequency identification (RFID) systems and methods are described that use RFID tags to exchange information between non-networked RFID readers. The RFID tags may store information about conditions the RFID-tagged items have encountered while being processed. RFID readers may dynamically update the information stored on the RFID tags as the RFID-tagged items are processed at nodes. An RFID tag may include a processor that dynamically determines process control instructions based on the information.

### TECHNICAL FIELD

The invention relates to radio frequency identification (RFID) systems for article management.

### BACKGROUND

Radio Frequency Identification (RFID) technology has become widely used in virtually every industry, including transportation, manufacturing, waste management, postal tracking, airline baggage reconciliation, and highway toll management. A typical RFID system includes a plurality of RFID tags, at least one RFID reader or detection system having an antenna for communication with the RFID tags, and a computing device to control the RFID reader. The RFID reader includes a transmitter that may provide energy and/or information to the tags, and a receiver to receive identity and other information from the tags. The computing device processes the information obtained by the RFID reader.

In general, the information received from an RFID tag is specific to the particular application, but often provides identification for an article to which the tag is fixed. Exemplary articles include manufactured items, books, files, animals or individuals, or virtually any other tangible article.

A conventional tag may be an “active” tag that includes an internal power source, or a “passive” tag that is energized by the field created by the RFID reader antenna. With a passive tag, the transmitter of the RFID reader outputs RF signals through the antenna creating an electromagnetic field that enables the tags to return an RF signal carrying the information. The transmitter makes use of an amplifier to drive the antenna with a modulated output signal. Once energized, the tags communicate using a pre-defined protocol, allowing the RFID reader to receive information from one or more tags. With an active tag, the tag may initiate communication with the RFID reader. In either case, the computing device serves as an information management system by receiving the information from the RFID reader and performing some action, such as updating a database. In addition, the computing device may serve as a mechanism for programming data into the tags via the transmitter.

Typical RFID systems include RFID tags that each store a unique identification (ID) number to identify an item with which the tag is associated. In many RFID applications, the RFID readers are typically part of a larger networked system that allows the RFID readers to communicate with one or more centralized databases. In other words, the networked system typically includes a plurality of networked RFID stations, where each RFID station includes a host computer coupled to one or more RFID reader. Such a networked system may be based on a hard-wired network or a wireless network. When a given RFID tag is interrogated by a RFID reader, the host computer coupled to the reader generally accesses a centralized database with an identification (ID) number of the tag to identify the object to which the tag is affixed, and perhaps to update data within the database or tag about the item. These conventional RFID applications often heavily rely on the underlying network to communicate information related to the processing of the objects. Network failure, therefore, may impact the performance or entirely disrupt the RFID application.

### SUMMARY

In general, non-networked radio frequency identification (RFID) systems, i.e., systems that are not conventionally-networked systems, and methods are described that use RFID tags themselves to exchange information between non-networked RFID readers. The RFID tags may be thought of as serving as the “physical layer” of a “network” within an RFID system. The RFID tags used in such a non-networked system may store more extensive information than conventionally stored on RFID tags, such as information about conditions the RFID-tagged items have encountered while being processed. RFID readers may dynamically update the information stored on the RFID tags as the RFID-tagged items are processed at nodes within the system.

In one embodiment, a radio frequency identification (RFID) tag comprises an integrated circuit that includes a memory to store information relating to conditions experienced by an item associated with the RFID tag at a first node of a system, and a processor that dynamically determines process control instructions based on the information. The RFID tag further comprises an antenna electrically coupled to the integrated circuit, wherein the antenna communicates the process control instructions to an RFID reader associated with a second node of the system to control processing of the item by the second node.

In another embodiment, a method comprises using a first radio frequency identification (RFID) reader to dynamically update information stored on an RFID tag at a first node of a system, wherein the updated information describes conditions experienced at the first node by an item with which the RFID tag is associated. The method further comprises transferring the item from the first node to a second node of the system, obtaining information from the RFID tag with a second RFID reader associated with the second node, and determining how to process the item at the second node based on the dynamically updated information obtained from the RFID tag.

In yet another embodiment, a method comprises sensing conditions experienced by an item at a first node of a system, wherein the item is associated with the RFID tag. The method further comprises, with the RFID tag, dynamically formulating instructions for processing the item at a second node of the system based on the sensed conditions experienced, and storing the dynamically formulated instructions within the RFID tag. The method further includes transferring the item from the first node to the second node, using an RFID reader at the second node to read the dynamically formulated instructions from the RFID tag, and processing the item with the second node in accordance with the instructions read by the RFID reader.

In another embodiment, a non-networked system for processing items comprises a plurality of items, wherein each of the items is associated with an radio frequency identification (RFID) tag that identifies the respective item and stores information about conditions experienced by the respective item during processing, and a plurality of nodes for processing the items, wherein each of the nodes includes an RFID reader for interrogating the RFID tags to obtain the information, wherein each of the nodes processes the items based on the information, and wherein the plurality of nodes is not connected via a network.

The techniques may provide one or more advantages. For example, in contrast to conventional networked RFID systems, the RFID tracking system described herein may be particularly useful in environments in which it is impractical to run hardwired network cabling, or in which distance or interference may prevent traditional wireless networks (e.g., 802.11) from operating. Since the RFID tracking system does not require a traditional network infrastructure, the RFID tracking system may be more quickly deployed than a conventional, networked system.

As another example, the RFID tracking system described herein may be used in conjunction with a traditional wired or wireless network. In one example embodiment, the RFID tracking system may operate together with the traditional network. The RFID tracking system and the traditional network may be separate but may share information or otherwise be linked. In the event the traditional network fails, the RFID tracking system may continue to operate, and may operate in place of the traditional network. Alternatively, the RFID tracking system may operate as a backup system to take over if the primary traditional network fails. In this manner, the RFID tracking system may ensure that processes continue to function, and information about the processes is stored even when the traditional network fails. The RFID tracking system may then forward the stored process information to the traditional network when it is brought back up.

As another example, existing nodes may be reconfigured and additional nodes and RFID readers may more easily be deployed within the RFID tracking system. Since traditional network capabilities are not required, RFID readers of a non-networked system may be simpler and less expensive. This may be advantageous in settings in which large numbers of RFID readers are required.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating an example manufacturing process having non-networked process nodes for processing RFID-tagged items.

FIG. 2 is a block diagram illustrating another example manufacturing process having non-networked nodes in which update tags are used for propagating process control updates between the nodes.

FIG. 3 is a block diagram illustrating another example manufacturing process that includes nodes for processing RFID-tagged items, and update tags for propagating process control updates to upstream nodes.

FIG. 4 is a block diagram illustrating an exemplary RFID tag for use with the RFID tracking system.

FIG. 5 is a block diagram illustrating example profile information of FIG. 6 in further detail.

FIG. 6 is a flowchart illustrating example operation of the RFID tracking system.

FIG. 7 is a flowchart illustrating example operation of the RFID tracking system.

### DETAILED DESCRIPTION

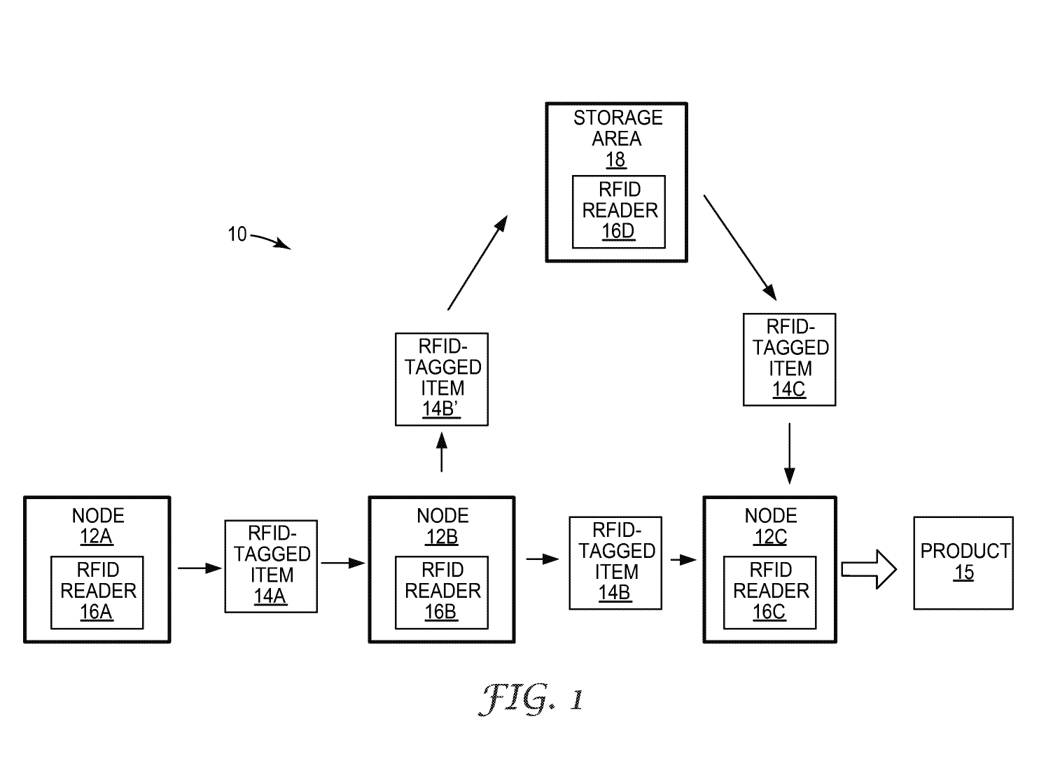

FIG. 1 is a block diagram illustrating an example manufacturing process 10. In the example of FIG. 1, manufacturing process 10 is shown in simplified form to include process nodes 12A-12C (“nodes 12”) for processing radio frequency identification (RFID)-tagged items 14A-14C (“RFID-tagged items 14”). In other words, nodes 12 may be stations within a manufacturing process or assembly line where discrete process steps are performed relative to items 14. Each of nodes 12 may include manufacturing equipment, such as extruders, rollers, coaters, heaters, coolers, or assembly equipment, for performing the corresponding process steps required to manufacture or assemble product 15 from RFID-tagged items 14. For example, items 14 may be raw or processed materials, components, or other items that are used during manufacturing process 10 to ultimately produce product 15.

In addition, each of nodes 12 has a respective RFID reader 16A-16D (“RFID readers 16”). RFID readers 16 of nodes 12 are not networked to one another in a conventional manner, i.e., RFID readers 16 are not required to be interconnected with network communication media (e.g. a Ethernet communication media) or via a traditional wireless network (e.g., a packet-based wireless network such as 802.11) in order for nodes 12 to exchange critical information or data for manufacturing process 10. Nor are RFID readers 16 in communication with a centralized database. Instead, nodes 12 exchange information via RFID tags carried by RFID-tagged items 14. Manufacturing process 10 is therefore referred to as “non-networked.”

The information or data communicated within manufacturing process 10 in such a non-networked manner may be used for a variety of purposes. For example, the information carried by RFID-tagged items 14 may include process parameters, algorithms, control instructions or other information to direct the manufacturing process steps at each of nodes 12. In addition, the RFID-tagged items 14 may collect information during manufacturing process 10 so as to provide a manufacturer with valuable data to understand the state of the manufacturing line, provide more accurate data or information related to the manufacturing processes, provide opportunities to improve the manufacturing processes, monitor compliance after improvements to the manufacturing processes have been implemented, and ultimately to improve business processes associated with the manufacturing process.

For example, non-networked nodes 12 may monitor the manufacturing process and store information within the RFID-tagged items 14 as the items 14 are processed, including information on different performance parameters affiliated with the efficiency of manufacturing process 10. For instance, the information may provide an indication of how much waste, byproducts or semi-finished goods manufacturing process 10 generates, which nodes 12 generate such waste or byproducts, which semi-finished goods are generated, and during what time frames. This gathered information may be helpful to the manufacturer to help it optimize or improve manufacturing process 10. In other words, the manufacturer of product 15 may use the gathered information to optimize or improve manufacturing process 10, reduce the overall unit cost for the items 14, products 15, and/or materials produced, maximize revenues, improve business processes and comply with regulatory requirements.

As another example, the information gathered by non-networked nodes 12 and stored within the RFID-tagged items 14 may allow the manufacturer to achieve certain goals that may not otherwise be achievable in a non-networked manufacturing environment. For example, the manufacturer may utilize the data collected and stored within the RFID tags of items 14 to monitor how long semi-finished goods are temporarily stored within storage area 18. Some semi-finished goods, for example, may have limited time during which they can be stored, due to regulatory issues, particularly in relationship to manufacturing processes for food products. As another example, the manufacturer may seek new methods of monitoring the residency or storage time of certain products during manufacturing process 10, particularly for food products, as they are manufactured to comply with regulatory requirements, such as product shelf life. As yet another example, the manufacturer may seek new methods in assisting it with product recalls, particularly with identifying sub lot portions of manufacturing process 10. As another example, the manufacturer may seek new ways of monitoring compliance with standard operating procedures, or for maintaining improvements to both manufacturing and business process improvements. The information gathered and stored within the RFID tags may help provide the manufacturer with the information they require to address these or other scenarios.

In the example of FIG. 1, RFID-tagged items 14 move between nodes 12 of the manufacturing process, and possibly to storage area 18 during the process. The RFID tags of RFID tagged items 14 may be affixed to an actual item to be processed, or to a container that holds the item or items produced in the manufacturing process, e.g., waste. The RFID tags may be initially programmed with some information, such as at the time of their manufacture or by a node 12 within manufacturing process 10. Manufacturing process 10 may be deployed within a manufacturing facility, and nodes 12 may be different stations used in the process for manufacturing items to produce product 15.

RFID-tagged item 14A initially undergoes processing at node 12A, and at that time is within the read range of RFID reader 16A associated with node 12A. RFID reader 16A reads information stored on an RFID tag of RFID-tagged item 14A. Such information read from the RFID tag may include information for processing the particular item 14A. RFID reader 16A may also write information to the RFID tag of RFID-tagged item 14A. For example, RFID reader 16A may write one or more timestamps to the RFID tag, e.g., the time RFID-tagged item 14A arrives at node 12A and the time RFID-tagged item 14A leaves node 12A. As another example, RFID reader 16A may record to the RFID tag process parameters or other settings that were used or sensed during the process steps performed by node 12A. For example, RFID reader 16A may write a temperature and a duration for which the item was subjected to the temperature, a paint color that was used to paint the item, or other process parameters. RFID-tagged item 14A is then transferred from node 12A to node 12B, e.g., by way of a conveyor.

At node 12B, the RFID tag of RFID-tagged item 14A is interrogated by RFID reader 16B. RFID reader 16B may retrieve all information stored within the RFID tag of RFID-tagged item 14A, or may access only certain portions of the information. Node 12B may determine whether and how to process RFID-tagged item 14A based on the information obtained by RFID reader 16B, including information that was stored to RFID-tagged item 14A at node 12A. For example, if RFID-tagged item 14A was processed at node 12A at a low temperature, node 12B may determine that node 12B should process RFID-tagged item 14A in a different manner than would otherwise be necessary, such as for a longer time period. After processing RFID-tagged item 14A, node 12B may also write information (e.g., timestamps and process parameters) to the RFID tag of RFID-tagged item 14A, and forward the item as RFID tagged item 14B to node 12C.

In this manner, the process information recorded at node 12A may be used by downstream node 12B to control or otherwise influence the particular processing steps performed by node 12B. In addition, a node 12 may dynamically modify its stored process parameters for use when processing all subsequent RFID-tagged items 14 based on information learned from one or more of RFID-tagged items 14. This process of dynamic learning and modification of process parameters may improve process efficiency and effectiveness. As another example, node 12B may decide to reroute RFID-tagged item 14A to a different node 12 (e.g., bypassing node 12C) based on the information stored on the RFID tag.

In some embodiments, node 12A may read the RFID tag of RFID-tagged item 14A, process RFID-tagged item 14A, and write information to the RFID tag of RFID-tagged item 14A. Then, instead of immediately transferring RFID-tagged item 14A to another node 12, node 12A may read the information that has been stored on the RFID tag of RFID-tagged item 14A and perform additional processing steps to RFID-tagged item 14A based on the information. RFID-tagged item 14A may then be transferred to node 12B for further processing. The re-reading of RFID-tagged item 14A may be necessary where two different process steps are performed at the same node. In some cases, however, node 12A may buffer the information regarding conditions experienced by RFID-tagged item 14A between process steps, and only read and write to the RFID tag after node 12A is completely finished processing RFID-tagged item 14A.

RFID-tagged items 14 may also be transferred to a storage area 18 at some point during the manufacturing process, such as when in a semi-finished form, e.g., as RFID-tagged item 14B′. Storage area 18 may be, for example, storage shelving, a cooling container, or other space within a manufacturing facility, or a separate manufacturing facility at a location some distance from the manufacturing facility of nodes 12. Storage area 18 may have one or more RFID readers, such as RFID reader 16D, to interrogate RFID-tagged items 14 that are stored within storage area 18. RFID reader 16D may write information to RFID tags of RFID-tagged items 14 while the items are stored within storage area 18, such as timestamps, environmental conditions of the storage area (e.g., temperature and humidity), or other information. Such information may be useful in determining the quality or safety of items stored within storage area 18. For example, when RFID-tagged item 14C arrives at node 12C, RFID reader 16C interrogates RFID-tagged item 14C and determines that RFID-tagged item 14C was stored in storage area 18 for a particular time period. If this time period is longer than an appropriate shelf life for RFID-tagged item 14C, RFID reader 16C may write information to the RFID tag of RFID-tagged item 14C indicating that RFID-tagged item 14C is unfit for a particular purpose, or may determine to process RFID-tagged item 14C differently or to forward RFID-tagged item 14C to a particular node based on the storage time.

In this manner, the techniques of this invention may be used to identify RFID-tagged items 14 as appropriate for different grades of product. For example, if RFID-tagged item 14C was stored in storage area 18 for too long, node 12C may determine that RFID-tagged item 14C is not an appropriate candidate to be incorporated into a “Grade A” product, but is an appropriate candidate to be incorporated into a “Grade B” product. Node 12C may then direct RFID-tagged item 14C to the appropriate node 12 based on this determination. For example, a “Grade B” item may skip certain nodes 12 of the manufacturing process. Some of nodes 12 may not perform any processing steps of the manufacturing process, but may instead serve to direct RFID-tagged items 14 along different paths within the manufacturing facility based on information read from the RFID tags. These techniques may result in a single manufacturing line that can produce products having a variety of characteristics.

In general, each of nodes 12 may perform analysis of information obtained from the RFID tags associated with RFID-tagged items 14, where the information may represent the item-specific environmental conditions or processing steps experienced by RFID-tagged items 14 during upstream processing. This information may be used to control or influence the processing at the given node 12. In addition, each of nodes 12 may formulate item-specific instructions for subsequent (i.e., downstream) nodes, and store the item-specific instructions on the RFID tags of the items 14 to be transported to the next node 12. Similarly, the item-specific instructions are read by the RFID reader 16 at the next node 12 and may be used to influence the processing of the particular item 14. The term “conditions experienced” by an RFID-tagged item 14 may include actions or processes dynamically applied to the RFID-tagged item, as well as environmental conditions experienced. For example, being extruded, cut to a particular size, or applied with a particular paint, adhesive, or coating, may all be “conditions experienced” by an RFID-tagged item 14.

In another embodiment, the RFID tag of an RFID-tagged item 14 may include sufficient processing power and software to analyze the information received from the RFID reader 16 of each of the nodes 12 and, based on the analysis, to formulate and store instructions to control subsequent processing to be performed on the RFID tag. In other words, control software and computing resources may be embedded on the RFID tags so as to compute and/or adjust process control instructions for each of the nodes 12 based on the environmental and processing conditions experienced by the particular item 14. In this embodiment, when the RFID-tagged item 14 arrives at the next node 12, the RFID reader 16 of the node 12 need only retrieve the newly computed instructions for processing the item from the item's tag, and the node 12 processes the item according to the instructions.

In some embodiments the nodes 12 include integrated circuitry for sensing or otherwise determining process parameters that are applied to RFID-tagged items 14 during processing, and which may be written to the RFID tags. In some embodiments, instead of receiving information about process parameters from the nodes 12 via RFID readers 16, the RFID tags may themselves have integrated sensors, which may be powered by the RFID tags. For example, an RFID tag on an RFID-tagged item 14 may have a temperature sensor to monitor the temperature of its surrounding environment. In these embodiments, the RFID tags may log temperatures experienced (i.e., the temperatures experienced by the item with which the RFID tag is associated), and can report this information when interrogated by an RFID reader 16.

RFID readers 16 located at nodes 12 throughout manufacturing process 10 may each include a radio receiver to receive time signals and enable each RFID reader 16 to be synchronized with an accurate time. For example, the radio receiver may be a non-RFID radio receiver for receiving non-RFID signals (e.g., a high frequency receiver, a shortwave radio receiver, a “WWV” receiver, or other non-RFID radio receiver). A WWV receiver receives radio broadcasts from the WWV or WWVH radio stations that continuously broadcast a high frequency signal indicating the current time and date. This may allow RFID readers 16 to record accurate timestamps to RFID tags during manufacturing process 10.

Alternatively, one or more RFID tags may include a WWV receiver. These RFID tags may be used to synchronize clocks of RFID readers 16. For example, the RFID tags may maintain a data structure for storing the current time as received via the WWV receiver. When an RFID reader 16 interrogates an RFID tag that includes a WWV receiver, the RFID reader 16 may access the current time value from the data structure, and update its current time value accordingly.

Only a limited number of RFID tags may have a WWV receiver, such that each RFID reader 16 has adequate access to such tags to keep its clock updated. In some embodiments all RFID tags may have a WWV receiver, while in other embodiments, certain dedicated clock RFID tags may be sent through manufacturing process 10 solely for purposes of updating clocks of RFID readers 16 at the nodes 12. One or more of the RFID tags may alternatively or additionally include a real-time clock within the tag electronics. The real-time clocks embedded within the RFID tags may be adjusted by RFID readers 16 as the RFID tags pass through specific nodes 12, or may conversely be used to adjust clocks maintained by the RFID readers 16.

In this manner, manufacturing process 10 does not rely on availability of a conventional network, which may at times become inoperable. Although embodiments described above may not require RFID readers 16 of manufacturing process 10 to be connected via a conventional network, nodes 12 may still be connected by a network of some type that is unrelated to the RFID tracking functions performed within RFID tracking system. For example, use of RFID tags to store and forward process information may act as a backup mechanism to a conventional network, which may have a centralized database to which the RFID readers are networked. When the conventional network fails, networked RFID tracking operations fail over, or the process control transfers, to the non-networked RFID system of manufacturing process 10. In this example, individual RFID tags and/or RFID readers 16 may store information until the conventional network again becomes operational, at which point the RFID tags and RFID readers 16 would forward the information to a centralized database. This application may be useful in situations in which manufacturing processes must continue even though personnel required to fix a failed network are unavailable for a period of time, such as on weekends. As another example, in some manufacturing layouts, information may be collected and stored within RFID tags as described above in a non-networked fashion, and the information is transferred from the RFID tags to a centralized database at only one node within manufacturing process 10, such as the final node. This format may reduce system bandwidth requirements and also reduce the risk of substantial disruption due to network failure. This may be advantageous where large amounts of data or a large number of RFID-tagged items 14 are being considered at many nodes 12 at any given time.

Storing process information and parameters on the RFID tags of RFID-tagged items 14 also may facilitate access to the data at the location of the RFID-tagged items 14 using handheld readers or other portable RFID readers. Having this information available locally may be faster or more convenient than requiring access to a centralized database, especially for non-networked portions of a manufacturing environment, or when a network fails.

One example of a practical application of the techniques described herein is within a manufacturing plant that produces packaged food items, that wishes to monitor waste generated at various points along a manufacturing line that currently has no reliable network. RFID readers 16 may be quickly set up at various nodes 12, e.g., collection points, to monitor waste carts fitted with RFID tags. Each time an RFID tag is within range of an RFID reader 16 of a collection point, the current time of the RFID reader 16 as well as the RFID reader's unique ID is recorded on the RFID tag. This information is updated as often as required, e.g., every one to five minutes. If the cart leaves the collection station, the first and last recorded timestamps, corresponding to the arrival and departure of the cart, are stored in the RFID tag. When the cart is brought to a central dump station, the contents of the cart may be weighed, and the information in the RFID tag read to determine the source location of the waste and the time spent at that location by the cart. With this information, decisions may be made regarding the waste generation point to improve process efficiencies. In addition, the information may be used to sort the waste for resale to companies that require assurance about material type. For example, ethanol producers require waste high in sugar content. If waste from only certain locations meets this criteria and the manufacturing plant can assure the ethanol producers that the waste they are buying did indeed come from that location, a premium could be charged for that waste.

For purposes of illustration, example implementations of the invention are described herein in the context of a manufacturing process; however, this context is merely exemplary, and the techniques may be applied to a variety of other contexts. For example, the techniques may be applied not only to items that are being manufactured, but also to supply items that are used in a manufacturing process. As another example, the techniques may be applied in the context of maintenance processes, including verification of parts, proper service processes, and so on. As another example, the techniques of the invention may be applied to a variety of environments where reliable networks may be unavailable, such as a hospital setting, a military setting, a prison setting, a library setting, an aerospace setting, or other settings. For example, instead of processing “items,” the techniques described herein could be used for directing individuals through a process, where each of the individuals is associated with an RFID tag (e.g., an RFID tag may be located within an identification bracelet worn by the individual).

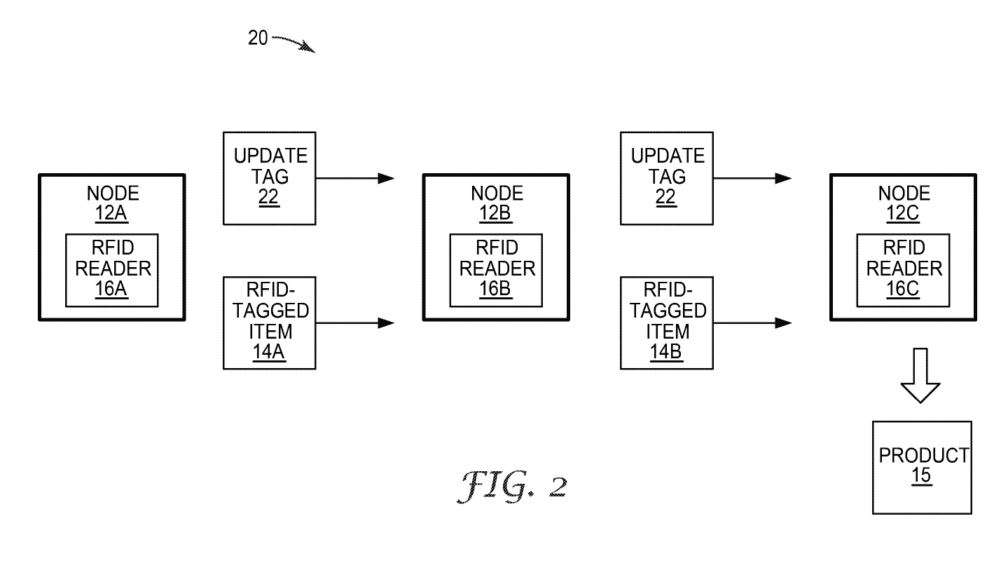

FIG. 2 is a block diagram illustrating another example manufacturing process 20 that includes non-networked nodes 12 for processing RFID-tagged items 14, and update tags 22 for propagating “updates” between nodes 12. For example, a special update tag 22 may be programmed to store algorithms or process control software to be downloaded and installed into one or more of nodes 12, thereby reconfiguring manufacturing process 20. The downloaded update may, for example, reconfigure the general path(s) that items 14 flow through manufacturing process 20, change an order or sequence of processing steps applied by any of nodes 12, apply a software patch to any of nodes 12 to fix or reconfigure process control software.

In the example of FIG. 2, node 12A may be a master node that programs update tags 22. Update tags 22 are then injected into manufacturing process 20, perhaps affixed to a “token” or “blank” item, for conveyance between nodes 12 to disseminate information for updating nodes 12. Update tags 22 may, for example, not be associated with an item to be processed, but may be attached to a token item, such as a container. Update tags 22 may be interspersed with RFID-tagged items 14 as the RFID-tagged items are conveyed to the different nodes 12 and processed as described above. In this manner, update information may be distributed to nodes 12 within manufacturing process 20 so as to reconfigure the manufacturing process 20 even though nodes 12 are not necessarily coupled to a network. In some cases, certain nodes 12 infrequently receive RFID-tagged items 14. Update tags 22 may be used to distribute information to these nodes 12 even when no RFID-tagged items 14 are received by these nodes 12.

In some embodiments, update tags 22 may also be used (or alternatively used) for collecting diagnostic information from nodes 12. For example, update tags 22 may collect information such as diagnostic reports on manufacturing equipment located at nodes 12, maintenance reports from the manufacturing equipment, reports of receive signals strength indicators (RSSI) to provide information as to whether adequate RF signals are present for reliable communications or other types of reports. As another example, update tags 22 may collect information regarding local environmental conditions at each of nodes 12, such as temperature, humidity, or other conditions. Update tags 22 may record a “status” of each node 12 encountered, such as whether the node 12 is functioning correctly. The diagnostic information may be used to diagnose system faults within nodes 12 or to aid identifying the source of manufacturing defects.

In some embodiments, manufacturing process 20 may be relatively large (in a geographical sense) and include both non-networked regions and conventionally-networked regions. Update tags 22 may be used to transmit information from networked regions to non-networked regions of manufacturing process 20. In addition to update information to be transmitted, update tags 22 may include information that identifies the source node and destination nodes of the update information. In some embodiments, instead of using separate update tags 22, RFID tags of RFID-tagged items 14 may be capable of carrying update information.

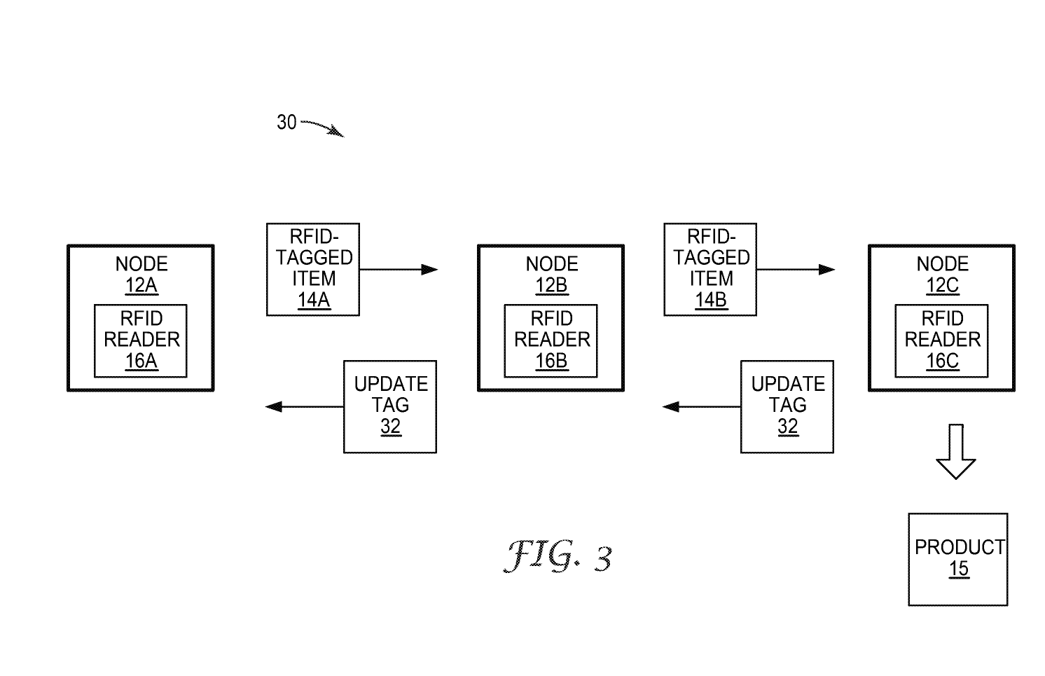

FIG. 3 is a block diagram illustrating another example manufacturing process 30 that includes nodes 12 for processing RFID-tagged items 14, and update tags 32 for feeding back process information from “downstream” nodes to “upstream” nodes. For example, in the example of FIG. 3, a manufacturing process may be set up to process RFID-tagged items 14 in order at first node 12A, then at node 12B, then at node 12C, i.e., from left to right. Thus, node 12A may be thought of as being “upstream” from nodes 12B and 12C, while node 12C may be thought of as being “downstream” from nodes 12A and 12B. Update tags 32 travel in the opposite direction as RFID-tagged items 14, and provide upstream nodes 12 with information from downstream nodes 12.

In this manner, update tags 32 may serve to provide a closed loop for information within manufacturing process 30. In one embodiment, update tags 32 may be the same tags as update tags 22 described in FIG. 2. In this embodiment, the update tags may carry information both downstream and upstream within the RFID tracking system, and may both distribute updates or programming information and distribute information learned by downstream nodes back to upstream nodes. The features described above with respect to FIGS. 1, 2, 3 may be used together in various combinations to form additional embodiments not enumerated.

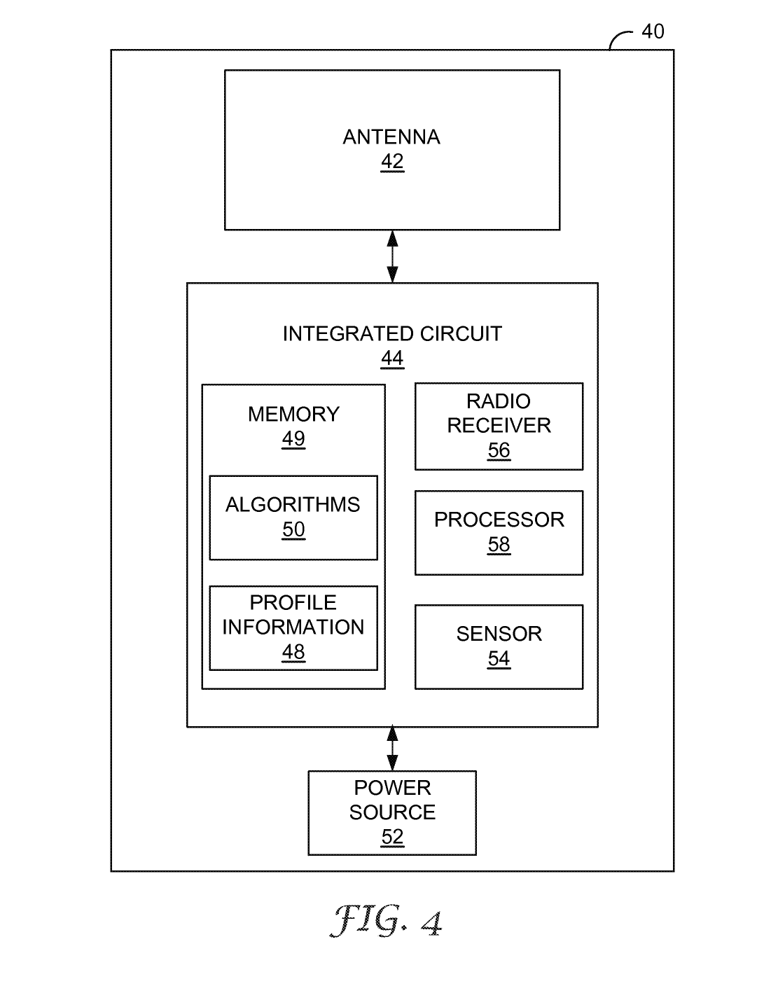

FIG. 4 a block diagram illustrating an exemplary RFID tag 40 for use with the RFID tracking systems of any of the manufacturing processes 10, 20 or 30 of FIGS. 1-3. In the illustrated embodiment of FIG. 4, RFID tag 40 includes an antenna 42 that is electrically coupled to an integrated circuit 44, often referred to as an “RFID chip.” Antenna 42 is “tuned” to operate at a particular frequency, which may be, for example, either the operating frequency of the RFID system, a lower frequency than the operating frequency, or a frequency higher than the operating frequency of the RFID system. For example, RFID tag 40 may operate at a frequency of approximately 915 MHz. As another example, RFID tag 40 may operate at a frequency of approximately 433 MHz. As yet another example, RFID tag 40 may operate at a frequency of approximately 13.56 MHz. The geometry and properties of antenna 42 depend on the desired operating frequency of the RFID tag. For example, RFID tags operating at 433 MHz, 915 MHz, or 2.45 GHz would typically include a dipole antenna, such as a linear dipole antenna or a folded dipole antenna. An RFID tag operating at 13.56 MHz (or similar) would typically use a spiral or coil antenna. However, other antenna designs are known to those skilled in the art. RFID tag 40 may be similar to an RFID tag used in conventional systems, and modified to satisfy the requirements of the RFID tracking systems described herein.

In operation, antenna 42 may receive RF energy from a source, and backscatter RF energy in a manner well known in the art. The backscattered RF energy provides a signal by which an interrogator, such as an RFID reader or detection system, obtains information from RFID tag 40 and, more particularly, about an article with which RFID tag 40 is associated.

RFID tag 40 may receive information from nodes 12 via antenna 42, such as information describing conditions experienced by the item with which RFID tag 40 is associated. For example, RFID tag 40 may receive environmental information, such as a temperature or humidity level. As another example, RFID tag 40 may receive process parameters for steps of a manufacturing process being performed upon the item, such as a paint color, or a temperature and time duration. RFID tag 40 may also receive timestamps from nodes 12. Integrated circuit 44 stores this information as profile information 48. Profile information 48 may be stored within internal memory 49 of integrated circuit 44. Other information may also be stored within the internal memory 49, such as information related to the article with which RFID tag 40 is associated.

In the example embodiment shown, RFID tag 40 may also store software algorithms 50 for determining process parameters or formulating instructions based on profile information 48. For example, RFID tag 40 may receive information describing conditions experienced by the item with which RFID tag 40 is associated, and store this information in profile information 48. A processor 58 within integrated circuit 44 of RFID tag 40 may execute algorithms 50 based on profile information 48 to compute or select process parameters or instructions (control logic) to be applied at subsequent nodes 12 within the manufacturing process when processing the RFID-tagged item with which tag 40 is associated. As described above, in some embodiments RFID tag 40 will not include algorithms. As another option, algorithms 50 may be downloaded to one or more of nodes 12 for computing or selecting instructions or additional parameters. For example, algorithms 50 may be stored on a computer-readable medium comprising instructions for causing a programmable processor to execute the algorithms.

In the embodiment of FIG. 4, RFID tag 40 is an active tag that includes power source 52. Power source 52 may provide power to sensor 54, which senses values of parameters reflecting one or more conditions within the environment to which RFID tag 40 is exposed. For example, sensor 54 may be a heat or humidity sensor. Integrated circuit 44 may store the parameter values sensed by sensor 54. RFID tag 40 may also include a radio receiver 56. RFID tags may use radio receiver 56 to receive non-RFID signals indicating the current time, and store the current time in profile information 48. RFID readers may read the stored current time to adjust or synchronize their clocks or the clocks of nodes 12.

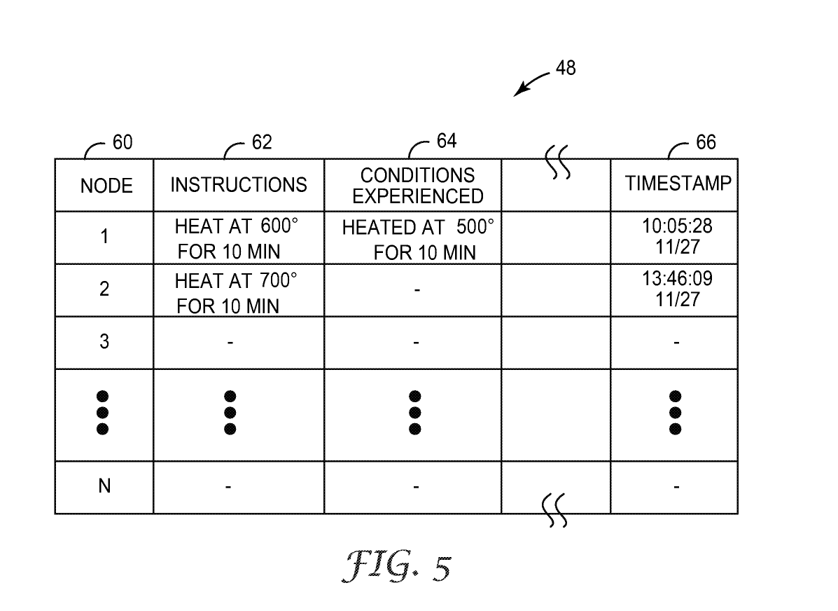

FIG. 5 is a block diagram illustrating example profile information 48 of FIG. 4 in further detail. In the example of FIG. 5, profile information 48 includes a node column 60 that corresponds to a node (i.e, stage or station) of a manufacturing process. Instructions column 62 stores instructions that instruct a node to perform certain item-specific actions on the RFID-tagged item at the corresponding stage. Conditions experienced column 64 provides storage space for the node or the tag to record conditions that the RFID-tagged item experienced at the respective node, such as a processing duration, temperature, humidity, and the like. Timestamp column 66 includes timestamps stored by the nodes, such as a timestamp for when the RFID-tagged item arrived at the node and/or was forwarded by the node. Profile information may be stored as an indexable array data structure, such that the first node in a process reads instructions from the first entry, the second node reads instructions from the second entry, and so on.

Profile information 48 may contain additional columns for recording additional information, e.g., the weight of the RFID-tagged item, an identifier of the node that has written information to profile information 48, or other information. Profile information 48 may be maintained in the form of one or more tables, databases, link lists, radix trees, databases, flat files, or any other data structures.

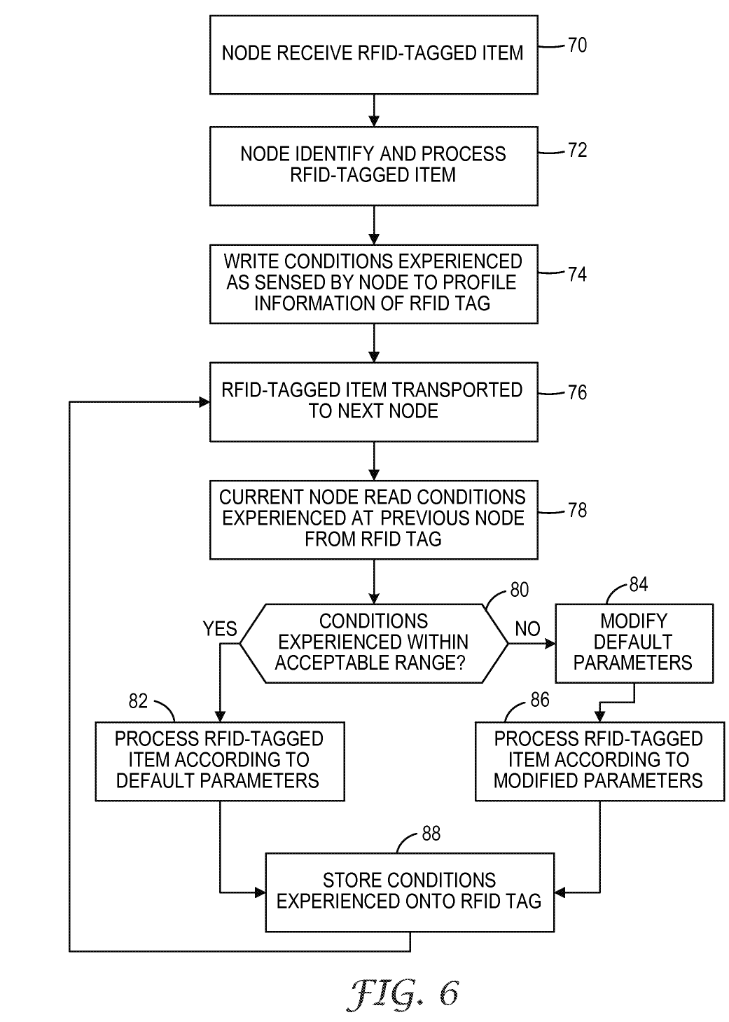

FIG. 6 is a flowchart illustrating example operation of an exemplary embodiment of a manufacturing process implementing a non-networked RFID system. FIG. 6 is described in terms of FIGS. 1, 4, and 5 above, and may also apply to the other FIGS. Node 12A receives RFID-tagged item 14A (70). A host computer associated with node 12A identifies RFID-tagged item 14A using RFID reader 16A to read RFID tag 40 (FIG. 4) associated with RFID-tagged item 14A, and processes RFID-tagged item 14A (72). Node 12A may determine how to process RFID-tagged item 14A based on the identification, e.g., by setting process parameters or by altering the process steps performed by node 12A. In some embodiments, RFID tag 40 associated with the RFID-tagged item 14A may be preloaded with process control instructions 62, and RFID reader 16A reads the instructions corresponding to the appropriate stage that node 12A represents in an overall process, i.e., node 1.

RFID reader 16A writes the conditions experienced by RFID-tagged item 14A at node 12A to profile information 48 stored on RFID tag 40, based on information sensed by node 12A (74). For example, as shown in profile information 48 of FIG. 5, although the instructions for node 1 called for heating at 600° for ten minutes, node 12A sensed that RFID-tagged item 14A was heated at 500° for ten minutes, and recorded this in conditions experienced column 64. RFID reader 16A may also record other information, such as the weight of RFID-tagged item 14A, timestamps, or other information.

RFID-tagged item 14A is transported to the next node of the process, i.e., node 12B (76). Node 12B reads the conditions experienced at the previous node, i.e., at node 1 of profile information 48 (78). If the conditions experienced fall within an acceptable range of conditions (YES branch of 80), node 12B may process RFID-tagged item 14A according to the default parameters stored within 12B. If the conditions experienced do not fall within the acceptable range of conditions (NO branch of 80), node 12B may modify the default parameters to compensate (84), and process the RFID-tagged item 14A according to the modified parameters (86). The conditions experienced by RFID-tagged item 14A at node 12B are stored onto profile information 48 of RFID tag 40 under node 2. The process may repeat as RFID-tagged item 14A is transferred to additional nodes 12.

In an alternative embodiment, node 12A may determine whether process control instructions for processing at the next node must be modified based on the conditions experienced at node 12A. In this case, RFID reader 16A may write the dynamically modified instructions to the node 2 instruction field 62 of profile information 48, and the instructions are then read and carried out by node 12B.

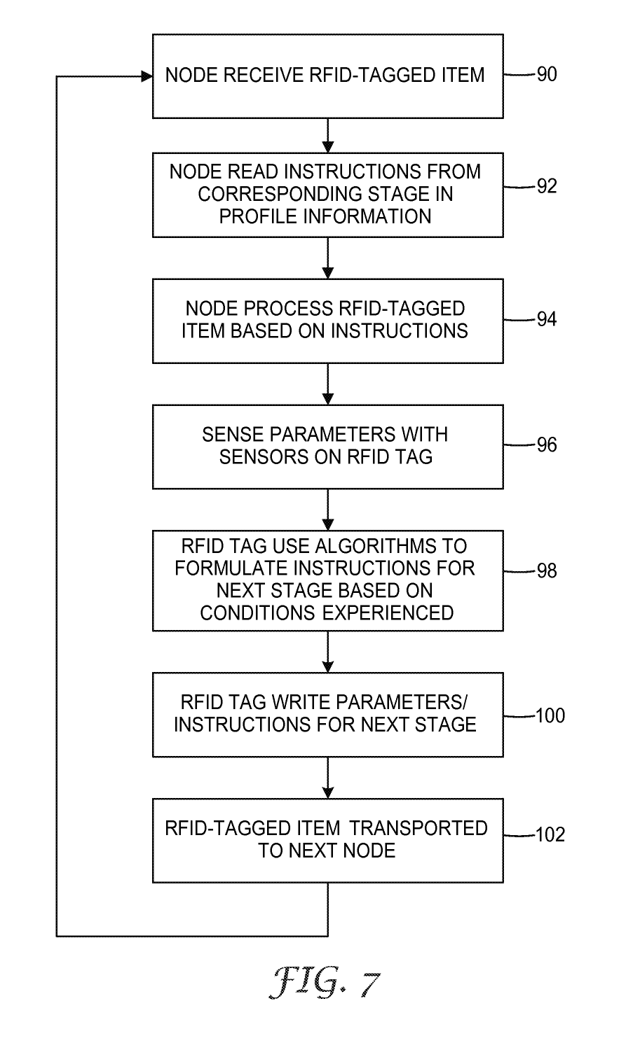

FIG. 7 is a flowchart illustrating example operation of another exemplary manufacturing process implementing a non-networked RFID system. FIG. 7 is described in terms of FIGS. 1, 4, and 5 above, and may also apply to the other FIGS. Node 12A receives RFID-tagged item 14A (90). Node 12A reads instructions from the corresponding node 1 field in profile information 48 of RFID tag 40 using RFID reader 16A (92), and processes RFID-tagged item 14A based on the instructions (94). Sensor 54 of RFID tag 40 senses values of one or more parameters relating to conditions experienced by RFID-tagged item 14A (96). A processor 58 (e.g., a processing core or, more specifically, a CPU) within integrated circuit 44 of RFID tag 40 executes algorithms 50 that use the sensed parameters to generate or select process control instructions and/or parameters to be applied at one or more subsequent nodes (stages) of processing (98). Integrated circuit 44 writes the instructions and/or parameters to profile information 48 for the next stage of processing (100). RFID-tagged item 14A is then transported to node 12B (102), and the process continues.

Although described above in terms of discrete processes, the techniques disclosed herein may also be applied in the context of continuous processes, such as a manufacturing environment for producing webs or rolls. For example, RFID tags may be conveyed in conjunction with a continuous web to control the manufacturing process for the web.

Various embodiments of the invention have been described. Features described above as relating to different embodiments may be combined together in a number of ways to form other embodiments. These and other embodiments are within the scope of the following claims.

1. A radio frequency identification (RFID) tag comprising:
an integrated circuit that includes:
a memory to store information relating to conditions experienced by an item associated with the RFID tag at a first node of a system, and
a processor that dynamically determines process control instructions based on the information; and
an antenna electrically coupled to the integrated circuit, wherein the antenna communicates the process control instructions to an RFID reader associated wit a second node of the system to control processing of the item by the second node.

2. The RFID tag of claim 1, further comprising a sensor for sensing a value of a parameter reflecting the conditions experienced by the item at the first node, wherein the integrated circuit stores the value in the memory.

3. The RFID tag of claim 2, further comprising a power source that provides power to the sensor.

4. The RFID tag of claim 3, wherein the power source further provides power for communicating the instructions to the RFID reader associated with the second node.

5. The RFID tag of claim 1, wherein the integrated circuit receives the information relating to the conditions experienced by the item at the first node via the antenna from an RFID reader associated with the first node.

6. The RFID tag of claim 1, further comprising a radio receiver to receive non-RFID signals indicating a current time, wherein the integrated circuit updates a value of the current time stored in the memory, and wherein the antenna communicates the value of the current time to the RFID reader associated with the second node.

7. The RFID tag of claim 6, wherein the radio receiver comprises a WWV receiver.

8. The RFID tag of claim 1, wherein the RFID tag operates at a frequency of approximately 915 MHz.

9. The RFID tag of claim 1, wherein the RFID tag operates at a frequency of approximately 13.56 MHz.

10. The RFID tag of claim 1, wherein the memory stores process control updates for reconfiguring one or both of the first node and the second node.

11. The RFID tag of claim 1, wherein the information relating to conditions experienced by an item associated with the RFID tag comprises at least one of a temperature value and a humidity value.

12. A method comprising:
using a first radio frequency identification (RFID) reader to dynamically update information stored on an RFID tag at a first node of a system, wherein the updated information describes conditions experienced at the first node by an item with which the RFID tag is associated;
transferring the item from the first node to a second node of the system;
obtaining information from the RFID tag with a second RFID reader associated with the second node; and
determining how to process the item at the second node based on the dynamically updated information obtained from the RFID tag.

13. The method of claim 12, wherein the first RFID reader is not connected to the second RFID reader via a network, and wherein neither the first RFID reader nor the second RFID reader is connected to a centralized database.

14. The method of claim 12, wherein determining how to process the item comprises dynamically modifying one or more steps of a process to be performed on the item at the second node based on the dynamically updated information.

15. The method of claim 14, wherein dynamically modifying one or more steps of the process comprises dynamically modifying one or more steps when the conditions experienced by the item at the first node are outside an acceptable range.

16. The method of claim 12, further comprising dynamically modifying one or more steps of the process when a primary network fails.

17. The method of claim 12, wherein determining how to process the item comprises processing the item at the second node based on default parameters when the conditions experienced by the item at the first node are within an acceptable range.

18. The method of claim 12, further comprising:
prior to transferring the item from the first node to a second node, obtaining information from the RFID tag with the first RFID reader; and
determining how to process the item at the first node based on the dynamically updated information obtained from the RFID tag.

19. A method comprising:
sensing conditions experienced by an item at a first node of a system, wherein the item is associated with the RFID tag;
with the RFID tag, dynamically formulating instructions for processing the item at a second node of the system based on the sensed conditions experienced;
storing the dynamically formulated instructions within the RFID tag;
transferring the item from the first node to the second node;
using an RFID reader at the second node to read the dynamically formulated instructions from the RFID tag; and
processing the item with the second node in accordance with the instructions read by the RFID reader.

20. The method of claim 19, wherein sensing the conditions experienced by the item comprises sensing using sensors within the RFID tag.

21. The method of claim 20, wherein the sensors are powered by a power source within the RFID tag.

22. The method of claim 19, wherein sensing the conditions experienced by the item comprises sensing using sensors at the first node.

23. A non-networked system for processing items, comprising:
a plurality of items, wherein each of the items is associated with an radio frequency identification (RFID) tag that identifies the respective item and stores information about conditions experienced by the respective item during processing; and
a plurality of nodes for processing the items, wherein each of the nodes includes an RFID reader for interrogating the RFID tags to obtain the information, wherein each of the nodes processes the items based on the information, and wherein the plurality of nodes is not connected via a network.

24. The non-networked system of claim 23, wherein each of the nodes determines how to process the items based on at least one of:
information stored on the RFID tags about conditions experienced by the items at previous nodes,
instructions stored on the RFID tags by RFID readers of previous nodes, or
instructions stored on the RFID tags by the RFID tags themselves.

25-26. (canceled)

27. The non-networked system of claim 23, further comprising an RFID update tag for distributing process control updates among the plurality of nodes,
wherein the RFID update tag either distributes information from upstream nodes in a process to downstream nodes in the process or distributes information from downstream nodes in a process to upstream nodes in the process,
wherein the plurality of nodes process the items to manufacture a product.

28-30. (canceled)
